(19) United States
(12) Patent Application Publication
(10) Pub. No.: US 2006/0066234 A1
(43) Pub. Date: Mar. 30, 2006

(54) ORGANIC ELECTRO-LUMINESCENT DISPLAY PANEL AND METHOD OF FABRICATING THE SAME

(76) Inventors: Chun-Chung Lu, Taichung County (TW); Jie-Huang Wu, Taoyuan County (TW); Chih-Kwang Tzen, Pingtung County (TW); Shih-Kuei Lo, Taoyuan County (TW); Shuenn-Jiun Tang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/711,620

(22) Filed: Sep. 29, 2004

(51) Int. Cl. H05B 33/04; H05B 33/10

(52) U.S. Cl. 313/512; 313/504; 313/503; 445/25; 445/24

(57) ABSTRACT

An organic electro-luminescent display panel is described. The panel includes an organic electro-luminescent device layer on a substrate, a first barrier layer and a second barrier layer. Especially, the first barrier layer is disposed over the organic electro-luminescent device layer, and a gap is formed between the first barrier layer and the organic electro-luminescent device layer. The second barrier layer is disposed over the substrate covering the first barrier layer and the organic electro-luminescent device layer. The first barrier layer and the second barrier layer have a function of isolating the organic electro-luminescent device layer from oxygen, moisture and other contaminations.

### BACKGROUND OF THE INVENTION

1. Field of the Invention

The present invention generally relates to a display device and a method of fabricating the same. More particularly, the present invention relates to an organic electro-luminescent display panel and a method of fabricating the same.

2. Description of Related Art

With recent advancement in opto-electronic fabricating techniques and the maturity of semiconductor manufacturing processes, the development of flat panel display devices have proceeded quite rapidly. In particular, organic electro-luminescent displays have the advantages of no viewing angle restriction, low production cost, high response speed, low power consumption, wide operating temperature range, lightness and small volume occupancy. Accordingly, the organic electro-luminescent display has potential applications and can become the main trend for the next generation displays.

The organic electro-luminescent display performs display via recombination holes with electrons within the organic emitting layer for generating excitons. The organic emitting layer is easily deteriorated in presence of oxygen and moisture. Therefore, how to isolate the organic emitting layer from oxygen and moisture is an important issue.

FIG. 1 is a schematic cross-sectional view showing a conventional organic electro-luminescent display panel. As shown in FIG. 1, an epoxy sealant 104 is used to seal the substrate 100a and the cap 106 through UV curing so as to encapsulate the organic electro-luminescent device layer 102 between the substrate 100 and the cap 106. However, moisture easily infiltrates into the organic electro-luminescent device layer 102 between the substrate 100 and the cap 106 through the sealant 104 and damages the organic electro-luminescent device layer 102. In order to resolve the problem, a desiccant material 114 is usually formed on the cap 106 to absorb moisture. But this method is only suitable for bottom emission organic electro-luminescent display panel. If this method is applied to top emission organic electro-luminescent display panel, the aspect ratio is significantly decreased.

For isolating the organic electro-luminescent device layer 102 from moisture, another conventional method suitable for top emission organic electro-luminescent display panel is described. As shown in FIG. 2, a vapor evaporation process is performed to form an organic layer 110 and an inorganic layer 112 alternately to completely cover the organic electro-luminescent device layer 102. Because the organic layer 110 and the inorganic layer 112 are transparent, the method can be applied to top emission organic electro-luminescent display panel. However, the process to fabricate the organic layer 110 and an inorganic layer 112 is complex. The residual thermal stress easily remains on the organic and inorganic layers 110, 112 and thus adversely affecting the organic electro-luminescent device layer 102.

### SUMMARY OF THE INVENTION

Accordingly, the present invention is directed to an organic electro-luminescent display panel capable of isolating the organic electro-luminescent device layer from moisture, oxygen and other contaminations.

The present invention is directed to a method of fabricating an organic electro-luminescent display panel. The method is suitable for both top and bottom emission organic electro-luminescent display panel.

According to an embodiment of the present invention, an organic electro-luminescent display panel comprising an organic electro-luminescent device layer, a first barrier layer and a second barrier layer is provided. The organic electro-luminescent device layer is disposed over a substrate. The first barrier layer is disposed over the organic electro-luminescent device layer, wherein a gap is formed between the first barrier layer and the organic electro-luminescent device layer. The second barrier layer is disposed over the substrate covering the first barrier layer and the organic electro-luminescent device layer.

According to another embodiment of the present invention, a method of fabricating an organic electro-luminescent display panel is provided. An organic electro-luminescent device layer is formed over a substrate. A first barrier layer is formed over the organic electro-luminescent device layer, wherein a gap is formed between the first barrier layer and the organic electro-luminescent device layer. A second barrier layer is formed over the substrate covering the first barrier layer and the organic electro-luminescent device layer.

In the present invention, both the first barrier layer and the second barrier layer are used to isolate the organic electro-luminescent device layer from moisture, oxygen and other contaminations. Especially, a gap is formed between the first barrier layer and the organic electro-luminescent device layer so that the stress subjected to the first barrier layer does not affect the organic electro-luminescent device layer directly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view showing a conventional organic electro-luminescent display panel.

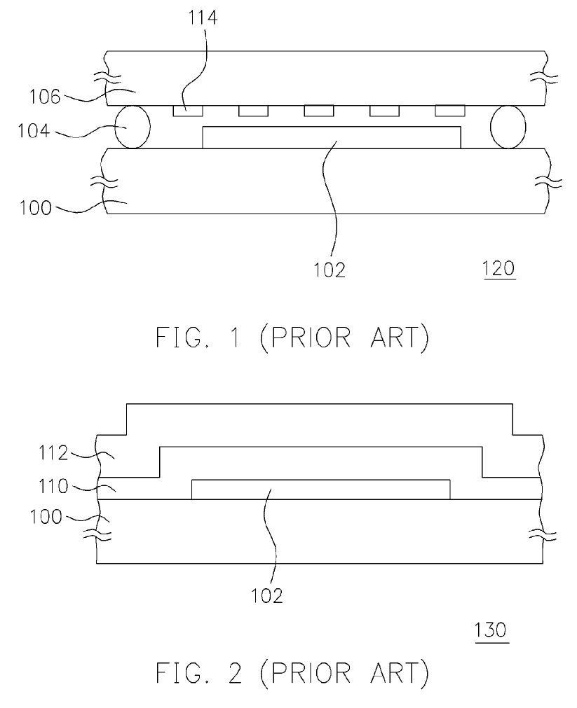

FIG. 2 is a schematic cross-sectional view showing another conventional organic electro-luminescent display panel.

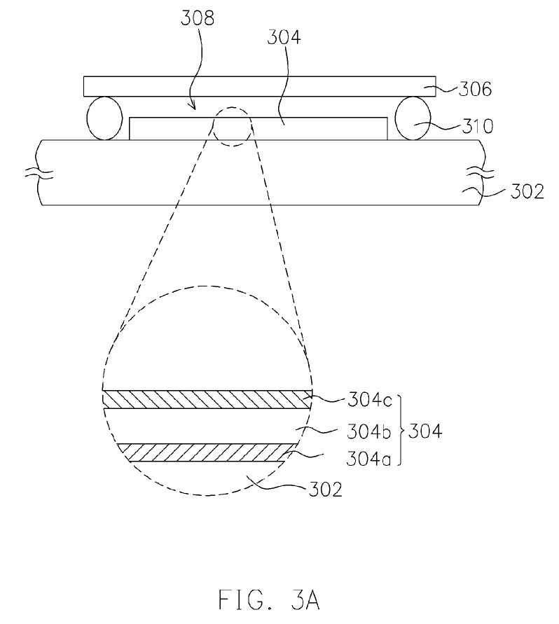

FIG. 3A˜FIG. 3C are schematic cross-sectional views showing the steps of fabricating an organic electro-luminescent display panel according to an embodiment of the invention.

FIG. 4 is a schematic cross-sectional view showing an organic electro-luminescent display panel according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

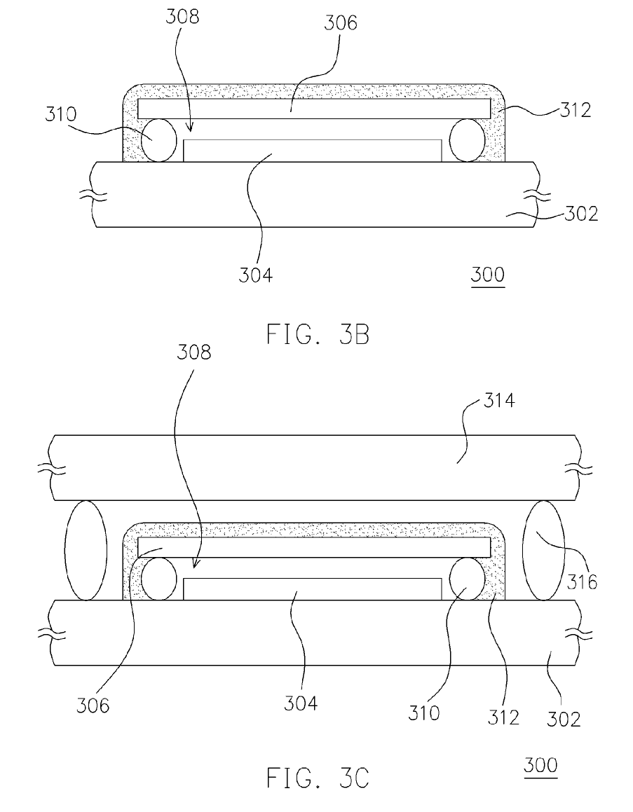

FIG. 3A˜FIG. 3C are schematic cross-sectional views showing the steps of fabricating an organic electro-luminescent display panel according to an embodiment of the invention. As shown in FIG. 3A, an organic electro-luminescent device layer 304 is formed over a substrate 302. The organic electro-luminescent device layer 304 comprises at least a first electrode layer 304a, an organic functional layer 304b and a second electrode layer 304c. In an embodiment, one of the first electrode layer 304a and the second electrode layer 304c is a transparent electrode layer. In another embodiment, both the first electrode layer 304a and the second electrode layer 304c are transparent. The organic electro-luminescent device layer 304 may be an active matrix organic electro-luminescent device layer or a passive organic electro-luminescent device layer. If the organic electro-luminescent device layer 304 is an active matrix organic electro-luminescent device layer, the first electrode layer 304a is constituted of several pixel electrodes (anode) while the second electrode 304c is a common electrode (cathode). If the organic electro-luminescent device layer 304 is a passive organic electro-luminescent device layer, the first electrode layer 304a is constituted of several parallel electrode strips (anode) while the second electrode 304c is constituted of another several parallel electrode strips (cathode) perpendicular to the electrode strips of first electrode layer 304a. The detail constructions of the active matrix organic electro-luminescent device layer and the passive organic electro-luminescent device layer are not drawn in FIG. 3A, and they are well known in the prior art. In an embodiment, the organic functional layer 304b includes at least an organic emitting layer. The organic functional layer 304b may further comprise an electron transmission layer, a hole transmission layer, an electron injection layer and a hole injection layer.

As shown in FIG. 3A, a first barrier layer 306 is disposed over the organic electro-luminescent device layer 304, and a gap 308 is formed between the first barrier layer 306 and the organic electro-luminescent device layer 304. Especially, the first barrier layer 306 has a thickness so as to provide a sufficient mechanical strength, and thereby the gap 308 can be formed between the first barrier layer 306 and the organic electro-luminescent device layer 304. The first barrier layer 306 has a thickness in a range of about 150˜300 μm, for example. The first barrier layer 306 is formed with a molding process or other suitable process, and then the first barrier layer 306 is disposed over the organic electro-luminescent device layer 304. In an embodiment, the first barrier layer 304 is an organic layer, for example. Preferably, the organic layer is selected from the group consisting of acrylic, methacrylic, polyester (PET), polyethyleneterephthalate, polyethylene (PE), polypropylene and a combination thereof.

In an embodiment, the method of forming the first barrier layer 306 over the organic electro-luminescent device layer 304 and the gap 308 between the first barrier layer 306 and the organic electro-luminescent device layer 304 comprises, for example, forming a first sealant 310 on the substrate 302 surrounding the organic electro-luminescent device layer 304, and then the first barrier layer 306 is disposed over the organic electro-luminescent device layer 304 and is in contact with the first sealant 310. The first sealant 310 is cured so as to encapsulate the organic electro-luminescent device layer 304 between the substrate 302 and the first barrier layer 306, and the gap 308 is formed between the first barrier layer 306 and the organic electro-luminescent device layer 304. In an embodiment, the first sealant 310 is cured by using an ultraviolet (UV) curing process or by any other suitable curing process.

It should be noted that the method of forming the first barrier layer 306 over the organic electro-luminescent device layer 304 and the gap 308 between the first barrier layer 306 and the organic electro-luminescent device layer 304 is not limited herein. One skilled in the art can utilize other method to form the first barrier layer 306.

As shown in FIG. 3B, a second barrier layer 312 is formed over the substrate 302 covering the first barrier layer 306 and the organic electro-luminescent device layer 304 so as to further isolate the organic electro-luminescent device layer 304 from oxygen, moisture and other contaminations. In an embodiment of the present invention, the first sealant 310 is formed between the first barrier layer 306 and the substrate 302, and thus the first sealant 310 is also covered by the second barrier layer 312.

In an embodiment, the second barrier layer 312 is an inorganic layer, for example. The second barrier layer 312 has a thickness in a range of about 1˜5 μm, for example. The method of forming the second barrier layer 312 is implemented using a deposition process, for example. The second barrier layer 312 is an inorganic layer selected from the group consisting of oxide, nitride, carbonate, oxynitride and a combination thereof, for example. The oxide is selected from the group consisting of silicon oxide, aluminum oxide, titanium oxide, indium oxide, tin oxide, indium tin oxide and a combination thereof, for example. The nitride is selected from a group consisting of aluminum nitride, silicon nitride and a combination thereof, for example.

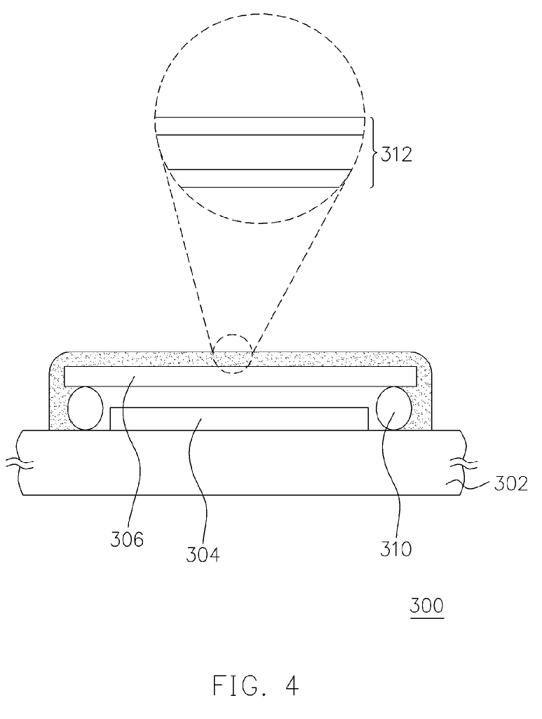

Especially, the second barrier layer 312 may also be, for example, a multiple layer, (as shown in FIG. 4) for increasing the isolation effect. The number of layers of the multiple layer is not limited herein.

The fabrication of the organic electro-luminescent display panel is substantially completed after the step of forming the second barrier layer 312 as shown in FIG. 3B. In an embodiment, after the step of FIG. 3B, a cap may further formed over the substrate 302 to protect the devices on the substrate 302 from damage during assembling or transportation.

The method of forming the cap over the substrate 302 is described as follows. As shown in FIG. 3C, a second sealant 316 is formed on the substrate 302 surrounding the resulting structure. A cap 314 is disposed above the substrate 302 and is contact with the second sealant 316. The second sealant 316 is cured so as to encapsulate the organic electro-luminescent device layer 304, the first barrier layer 306 and the second barrier layer 312 between the substrate 302 and the cap 314. In an embodiment, the second sealant 316 is cured by using ultraviolet (UV) process or by using any other suitable curing process. The cap 316 is a glass cap, a plastic cap or a metal cap, for example. The subsequent processes of the organic electro-luminescent display panel, such as testing, are similar to the conventional subsequent processes.

The organic electro-luminescent display panel fabricated by using the above mentioned process is shown as FIG. 3B. The panel 300 comprises at least an organic electro-luminescent device layer 304, a first barrier layer 306 and a second barrier layer 312. The organic electro-luminescent device layer 304 is disposed over the substrate 302. The organic electro-luminescent device layer 304 may be an active matrix organic electro-luminescent device layer or a passive organic electro-luminescent device layer. The first barrier layer 306 is disposed over the organic electro-luminescent device layer 304, and a gap 308 is formed between the first barrier layer 306 and the organic electro-luminescent device layer 304. The first barrier layer 306 is an organic layer, for example, and has a thickness in a range of 150˜300 μm, for example.

According to an embodiment of the present invention, a first sealant 310 is disposed between the first barrier layer 306 and the substrate 302. The barrier layer 306 and the substrate 302 are sealed through the first sealant 310 so as to encapsulate the organic electro-luminescent device layer 304 between the substrate 302 and the first barrier layer 306.

The second barrier layer 312 is disposed over the substrate 302 covering the organic electro-luminescent device layer 304 and the first barrier layer 306 to isolate the organic electro-luminescent device layer 304 from oxygen, moisture and other contaminations. The second barrier layer 312 is an organic layer, for example, and has a thickness in a range of 1˜5 μm, for example. The second barrier layer 312 may be a single layer (as shown in FIG. 3B) or a multiple layer (as shown in FIG. 4).

According to another embodiment of the present invention, the panel 300 further comprises a cap 314 and a second sealant 316, as shown in FIG. 3C. The second sealant 316 is disposed on the substrate 302, and the cap 314 is disposed above the substrate 302. The cap 314 and the substrate 302 are sealed through the second sealant 316 so as to encapsulate the organic electro-luminescent device layer 304, the first barrier layer 306 and the second barrier layer 312 between the substrate 302 and the cap 314.

Accordingly, both the first barrier layer and the second barrier layer are used to isolate the organic electro-luminescent device layer from oxygen, moisture and other contaminations. Especially, a gap is formed between the first barrier layer and the organic electro-luminescent device layer so that the stress subjected to the first barrier layer does not affect the organic electro-luminescent device layer directly. For example, if the first barrier layer is deformed under some stress during the fabrication of the panel, the organic electro-luminescent device layer underneath the first barrier layer is not damaged or deformed because a gap exist between the first barrier layer and the organic electro-luminescent device layer. Besides, the second barrier layer can be constituted of multi-layers so as to increase the isolation effect. Since oxygen, moisture and other contaminations do not infiltrate the organic electro-luminescent device layer, the lifetime of the panel can be improved.

In the present invention, the first barrier layer and the second barrier layer are transparent. If the first electrode and the second electrode of the organic electro-luminescent device layer are transparent, the cap is selected from a glass cap or other transparent cap. The panel of the invention can be a top emission organic electro-luminescent display panel, a bottom emission organic electro-luminescent display panel or a double-side emission organic electro-luminescent display panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An organic electro-luminescent display panel, comprising:
an organic electro-luminescent device layer, on a substrate;
a first barrier layer, disposed over the organic electro-luminescent device layer, wherein a gap is formed between the first barrier layer and the organic electro-luminescent device layer; and
a second barrier layer, disposed over the substrate covering the first barrier layer and the organic electro-luminescent device layer.

2. The organic electro-luminescent display panel according to claim 1, wherein the first barrier layer is an organic layer.

3. The organic electro-luminescent display panel according to claim 2, wherein the organic layer is selected from the group consisting of acrylic, methacrylic, polyester, polyethyleneterephthalate, polyethylene, polypropylene and a combination thereof.

4. The organic electro-luminescent display panel according to claim 1, wherein the first barrier layer has a thickness in a range of about 150˜300 μm.

5. The organic electro-luminescent display panel according to claim 1, wherein the first barrier layer is an inorganic layer.

6. The organic electro-luminescent display panel according to claim 5, wherein the inorganic layer is selected from the group consisting of oxide, nitride, carbonate, oxynitride and a combination thereof.

7. The organic electro-luminescent display panel according to claim 6, wherein the oxide is selected from the group consisting of silicon oxide, aluminum oxide, titanium oxide, indium oxide, tin oxide, indium tin oxide and a combination thereof.

8. The organic electro-luminescent display panel according to claim 6, wherein the nitride is selected from the group consisting of aluminum nitride, silicon nitride and a combination thereof.

9. The organic electro-luminescent display panel according to claim 1, wherein the second barrier layer is a multiple layer.

10. The organic electro-luminescent display panel according to claim 1, wherein the second barrier layer has a thickness in a range of about 1˜5 μm.

11. The organic electro-luminescent display panel according to claim 1, further comprising:
a first sealant, disposed between the substrate and the first barrier layer so as to encapsulate the organic electro-luminescent device layer between the substrate and the first barrier layer.

12. The organic electro-luminescent display panel according to claim 1, further comprising:
a cap, disposed above the substrate; and
a second sealant, disposed between the cap and the substrate so as to encapsulate the organic electro-luminescent device layer, the first barrier layer and the second barrier layer between the substrate and the cap.

13. The organic electro-luminescent display panel according to claim 1, wherein the organic electro-luminescent device layer is an active matrix organic electro-luminescent device layer or a passive organic electro-luminescent device layer.

14. A method of fabricating an organic electro-luminescent display panel, comprising:
forming an organic electro-luminescent device layer over a substrate;
forming a first barrier layer over the organic electro-luminescent device layer,
wherein a gap is formed between the first barrier layer and the organic electro-luminescent device layer; and
forming a second barrier layer over the substrate covering the first barrier layer and the organic electro-luminescent device layer.

15. The method of fabricating an organic electro-luminescent display panel according to claim 14, wherein the step of forming the first barrier layer over the organic electro-luminescent device layer comprises:
forming a first sealant on the substrate surrounding the organic electro-luminescent device layer;
disposing the first barrier layer over the substrate, wherein the first barrier layer is contact with the first sealant; and
curing the first sealant so as to encapsulate the organic electro-luminescent device layer between the substrate and the first barrier layer.

16. The method of fabricating an organic electro-luminescent display panel according to claim 14, wherein the step of forming the second barrier layer comprises performing a deposition process.

17. The method of fabricating an organic electro-luminescent display panel according to claim 14, further comprising a step of forming a cap over the substrate after the step of forming the second barrier layer.

18. The method of fabricating an organic electro-luminescent display panel according to claim 17, wherein the step of forming the cap over the substrate comprises:
forming a second sealant on the substrate;
disposing the cap over the substrate, wherein the cap is contact with the second sealant; and
curing the second sealant so as to encapsulate the organic electro-luminescent device layer, the first barrier layer and the second barrier layer between the substrate and the cap.
